(19) United States
(12) Patent Application Publication
(10) Pub. No.: US 2011/0178948 A1
(43) Pub. Date: Jul. 21, 2011

(54) METHOD AND SYSTEM FOR BUSINESS PROCESS ORIENTED RISK IDENTIFICATION AND QUALIFICATION

(75) Inventors: Feng Cheng, Chappaqua, NY (US); Henry H. Dao, Marlton, NJ (US); Markus Ettl, Yorktown Heights, NY (US); Mary E. Helander, Yorktown Heights, NY (US); Jayant Kalagnanam, Yorktown Heights, NY (US); Karthik Sourirajan, Yorktown Heights, NY (US); Changhe Yuan, Mississippi State, MS (US)

(73) Assignee: INTERNATIONAL BUSINESS MACHINES CORPORATION, Armonk, NY (US)

(21) Appl. No.: 12/690,339

(22) Filed: Jan. 20, 2010

(51) Int. Cl. G06Q 10/00; G06F 15/18; G06N 5/02

(52) U.S. Cl. 705/348; 706/12; 706/52

(57) ABSTRACT

A method and system for identifying and quantifying a risk is disclosed. In one embodiment, the method comprises forming a two-dimensional risk matrix, wherein a first dimension of the matrix comprises risk variable categories and a second dimension comprises standard business processes, placing a risk variable onto the two-dimensional risk matrix, wherein the risk variable is categorized by one of the risk variable categories and one of the standard business processes, connecting the variable node with another risk variable in the two-dimensional risk matrix, and applying a learning method to the two-dimensional risk matrix to compose a risk model to use for quantifying the risk. The system comprises a processor operable to perform the steps embodied by the method.

### BACKGROUND

The present invention relates generally to risk management and, particularly to a method and system that identifies and quantifies business risks and their effect on the performance of a business process.

The growth and increased complexity of the global supply chain has caused supply chain executives to search for new ways to lower costs. As a result, companies are exposed to risks that are far broader in scope and greater in potential impact than the recent past. The financial impact as a result of supply chain failures can be dramatic and may take companies a long time to recover.

Supply chain executives need to know how to identify, mitigate, monitor and control supply chain risk to reduce the likelihood of the occurrence of supply chain failures. Supply chain risk is the magnitude of financial loss or operational impact caused by probabilities of failure in the supply chain.

Risk identification and analysis can be heavily dependent on expert knowledge for constructing risk models. The use of expert knowledge elicitation is extremely time-consuming and error-prone. Experts may also possess an incomplete view of a particular industry. This can be alleviated in part by using multiple experts to provide complementary information. However, the use of multiple experts creates possibilities for inconsistent or even contradictory information.

Bayesian networks may also be used to construct risk models for business processes. However, there are typically many sub-processes related to the business process that need to be identified before a Bayesian network can be employed. Historical data for these sub-processes are often heterogeneous (stored in different formats that may be incompatible with other data). Further, the historical data may be stored across multiple database systems. Such data cannot easily be collected or used to construct a risk model.

Therefore, there is a need in the art for a method and system that allows a user to construct a risk model using expert knowledge, and a learning method such as a Bayesian network. The risk model may utilize historical data from a variety of sources to identify and quantify business risks and their effect on the performance of a business process.

### SUMMARY

A method and system for identifying and quantifying a risk is disclosed. In one embodiment, the method comprises forming a two-dimensional risk matrix, wherein a first dimension of the matrix comprises risk variable categories and a second dimension comprises standard business processes, placing a risk variable onto the two-dimensional risk matrix, wherein the risk variable is categorized by one of the risk variable categories and one of the business processes, associating the variable node with a target risk variable in the two-dimensional risk matrix, and applying a learning method to the two-dimensional risk matrix to compose a risk model to use for quantifying the risk, wherein a program using a processor unit performs one or more of said forming, placing, connecting, and applying steps.

In another embodiment, the system comprises a processor operable to form a two-dimensional risk matrix, wherein a first dimension comprises risk variable categories and a second dimension comprises business processes, place a risk variable onto the two-dimensional risk matrix, wherein the risk variable is categorized by one of the risk variable categories and one of the standard business processes, associate the risk variable with a target risk variable in the two-dimensional risk matrix, and apply a learning method to the two-dimensional risk matrix to compose a risk model to use for quantifying the risk.

A program storage device readable by a machine, tangibly embodying a program of instructions operated by the machine to perform above-method steps for identifying and quantifying a risk is also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1. is an example of a two-dimensional risk matrix in accordance with the present invention;

FIG. 2. is an example of a Bayesian risk model;

FIG. 3. is an example of a Bayesian risk model that benefits from the present invention;

FIG. 4. is an example of a bar chart illustrating the likelihood of risk states;

FIG. 5. is an example of a bar chart illustrating the impact of the risk states;

FIG. 6. is an example of a Monte Carlo analysis in accordance with the present invention;

FIG. 7 is an example of a risk quantification matrix in accordance with the present invention;

FIG. 8 is an example of an architecture that can benefit from the present invention; and

FIG. 9 is a software flowchart that illustrates one embodiment of the present invention.

### DETAILED DESCRIPTION

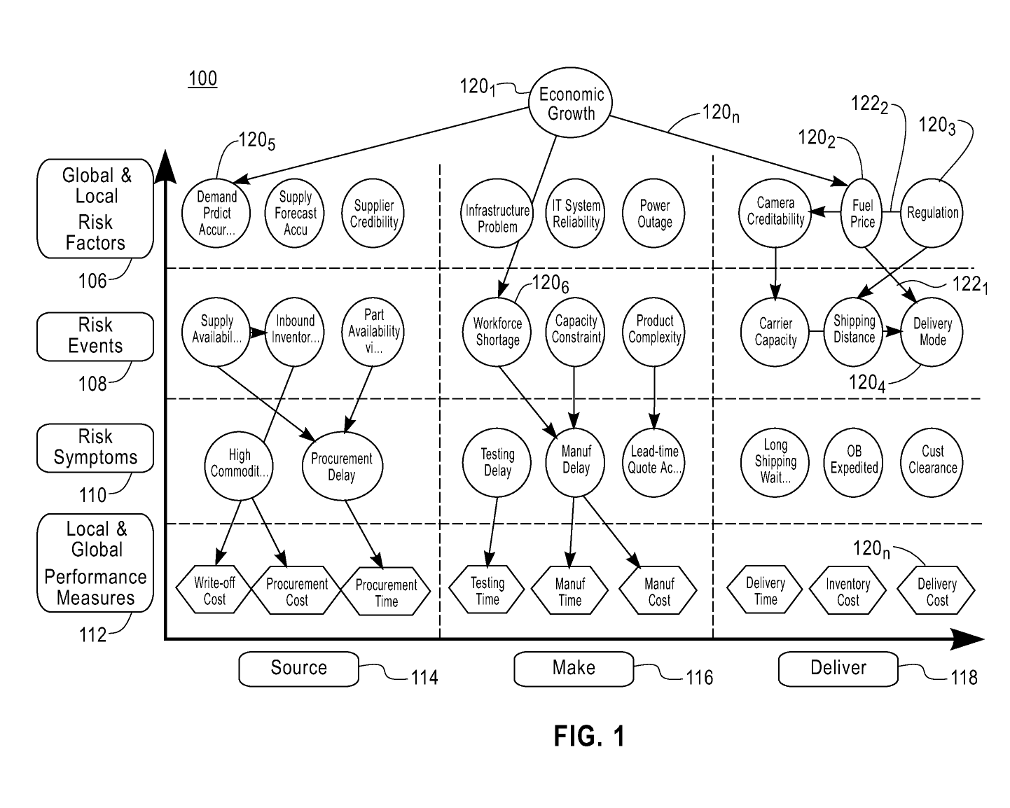

The following example and figures (FIGS. 1 to 9) illustrate the present invention as applied to sourcing, manufacturing, and delivering custom computer systems. However, the present invention is not limited to the computer industry. Any industry that utilizes supply chain management may benefit from the present invention. In the present example, a computer company sources computer parts from several sources, assembles the parts into a computer at a factory, and then delivers the final computer product to a customer. The computer is custom built according to customer specifications. Therefore, several risk variables such with the same reference numbers are used throughout the following example and figures.

FIG. 1. is an example of a two-dimensional risk matrix 100 generated in accordance with the present invention. In one embodiment, the two-dimensional risk matrix 100 forms a risk framework, with risk factors along the Y-axis of the matrix 100, and business processes along the X-axis of the matrix 100. As shown in FIG. 1, the risk factors may include global and local risk factors 106, risk events 108, risk symptoms 110, and 1 global and local risk factors 106. The business processes listed along the X-axis may be any standard business processes, such as the processes utilized in the Supply Chain Operations Reference model (SCOR model). The Supply-Chain Operations Reference-model (SCOR) is a process reference model developed by the management consulting firm PRTM and AMR Research and endorsed by the Supply-Chain Council (SCC) as the cross-industry de facto standard diagnostic tool for supply chain management. SCOR enables users to address, improve, and communicate supply chain management practices within and between all interested parties in the Extended Enterprise.

The SCOR model, as shown in FIG. 1, comprises the business processes source 114, make 116, and deliver 118. Additionally, the business processes “plan” and “return” (not shown in FIG. 1), are part of the SCOR model. The “plan” component of the SCOR model focuses on those processes that are designed to balance supply and demand. During the “plan” phase of the SCOR model, a business must create a plan to meet production, sourcing, and delivery requirements and expectations. The “source” 114 component of the SCOR model involves determining the processes necessary to obtain the goods and services needed to successfully support the “plan” component or to meet current demand. The “make” 116 component of the SCOR model involves determining the processes necessary to create the final product. The “deliver” 118 component of the SCOR model involves the processes necessary to deliver the goods to the consumer. The “deliver” 118 component typically includes processes related to the management of transportation and distribution. The final component of the SCOR model, “return”, deals with those processes involved with returning and receiving returned products. The return component of the SCOR model generally includes customer support processes.

One skilled in the art would appreciate that the present invention is not just limited to use of the SCOR model, and may benefit from other business processes models such as BALANCED SCORECARD™, VCOR, and eTOM™.

Risk variables 120 are entered in the risk matrix 100 by an expert. Risk variables are also known in the art as risk nodes. Each risk variable 120 may be a discrete value or a probabilistic distribution. In one embodiment, the expert enters the risk variables via a software program. The software program presents the expert with a questionnaire concerning a series of risks, and each risk is related to a specific risk variable. The expert inputs a probability or a discrete value associated with the risk. For example, the expert may be presented with a question such as “What will be the economic growth of the Gross Domestic Product (GDP) in the next year?” The expert will input a discrete value, such as 0.02, to the risk variable. The software program may also present a question to the expert such as “What is the likelihood of an earthquake occurring in a city in the next year?” The expert will input a probability value, such as 10%, to the risk variable. An exemplary method and system for eliciting risk information from an expert is disclosed in co-pending U.S. patent application Ser. No. 12/640,082 entitled “System and Method for Distributed Elicitation and Aggregation of Risk Information.” In one embodiment of the invention, the expert bases his opinion upon historical supply chain data to provide the input for each risk variable 120. In another embodiment of the invention, the expert bases his opinion upon personal knowledge of the risk variable to provide the input for each risk variable 120. Each risk variable 120 is further categorized according to one business process and one risk factor on the matrix 100. For example, the risk variable economic growth 120₁ is categorized according to the business process make 116 and global and local risk factors 106. The risk matrix 100 provides a framework for combining heterogeneous sources of information, including, but not limited to, expert knowledge, business process standards, and historical supply chain data.

Risk variables 120 are associated with other risk variables 120 by arcs 122. The arcs 122 are placed between risk variables 120 by the expert and indicate that a risk variable 120 provides an influence upon a target risk variable 120. In one embodiment, the influence derives from a risk variable 120 providing an input to a target risk variable 120. For example, arc 122₁ associates risk variable “fuel price” 120₂ with risk variable “delivery mode” 120₄. The risk variable “fuel price” 120₂ provides an input to the target risk variable “delivery mode” 120₄. The input provided from risk variable 120₂ is used to calculate a value for risk variable 120₄.

The risk matrix 100 illustrates the causal structure and dependent relationships among the risk variables 120. The Y-axis (vertical dimension) illustrates the causal relationship among the risk factors: global and local risk factors 106 affect risk events 108, risk events 108 affect risk symptoms 110, and risk symptoms 110 affect local and global performance measures 112. The risk matrix 100 also illustrates that global risk variables such as economic growth 120₁ affects multiple risk variables (“fuel price” 120₂, “demand predict accuracy”120₅, “workforce shortage”120₆), while local risk variables such as regulation 120₃ only affect other local risk variables such as fuel price 120₂.

A learning method is applied to the risk matrix 100 to further elucidate the relationships between the risk variables 120. In one embodiment of the invention, a Bayesian learning method is applied to the risk matrix 100. Standard Bayesian network learning methods are taught by Heckerman in “Learning Bayesian Networks: The Combination of Knowledge and Statistical Data”, Proceedings of the Tenth Conference on Uncertainty in Artificial Intelligence, 293-301, 1994. In another embodiment of the invention, a regression analysis learning method is applied to the risk matrix 100. In yet another embodiment, a process flow model learning method is applied to the risk matrix 100. In one embodiment, the Bayesian learning method known as the greedy thick thinning algorithm is applied to the risk matrix 100. The greedy thick thinning algorithm is further disclosed by Cheng in “An Algorithm for Bayesian Belief Network Construction from Data” Proceedings of AI & STAT, 83-90, 1997, which is incorporated by reference in its entirety. The learning method is constrained by the hierarchical structure of the risk matrix 100, and by the rules that govern how arcs 122 interconnect the risk variables 120. These constraints improve the efficiency of using the learning method to develop a risk model.

The learning method computes a closeness measure between the risk variables 120 based upon mutual information. In probability theory and information theory, the mutual information of two random variables is a measure of the mutual dependence of the two variables. Knowing a value for any one mutually dependent variable provides information about the other mutually dependent variable. The learning method then connects risk variables 120 together by an arc 122 if the risk variables 120 are dependent upon each other. Finally, the arc 122 is re-evaluated and removed if the two connected risk variables 120 are conditionally independent from each other. For example, if two risk variables A and B are conditionally independent given a third risk variable C, the occurrence or non-occurrence of A and B are independent in their conditional probability distribution given C).

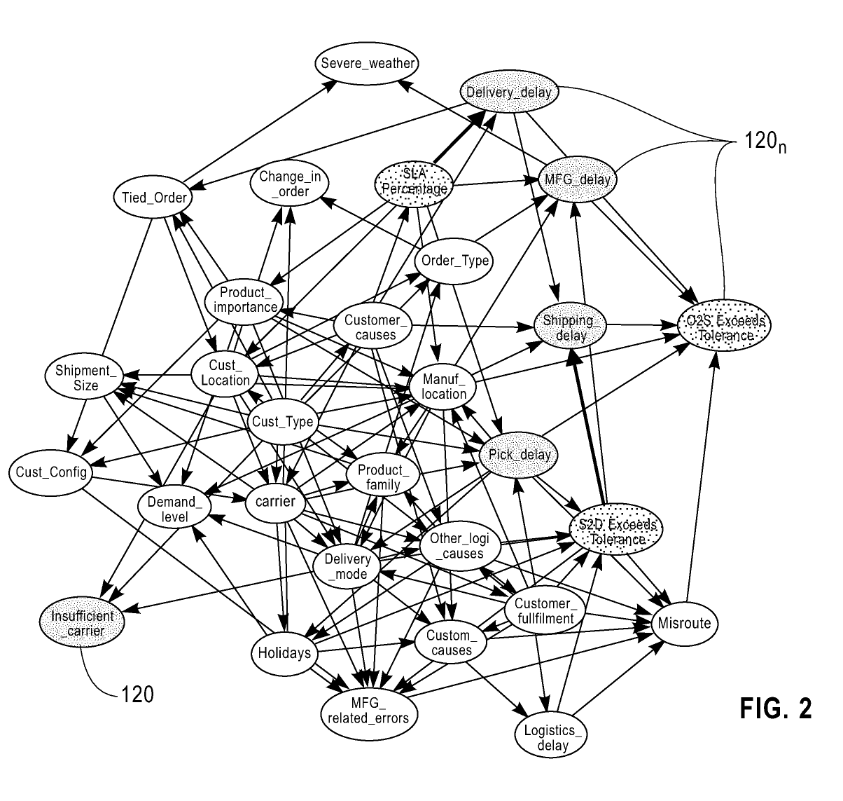

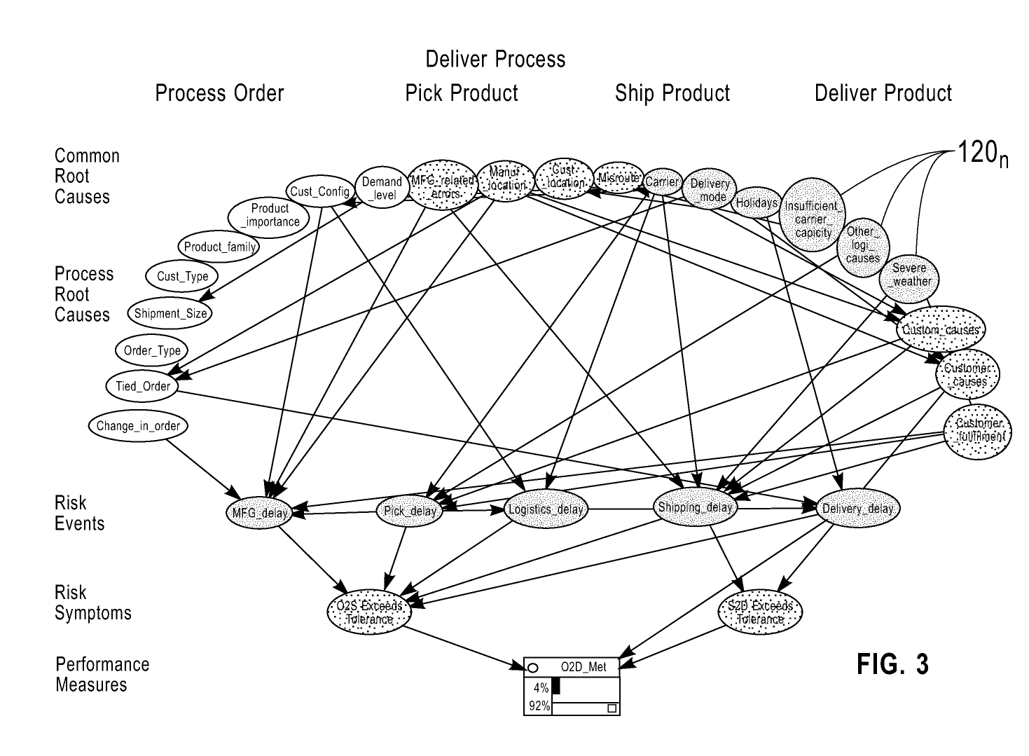

FIGS. 2 and 3 are examples of Bayesian risk models 200, 300, respectively, that further illustrate the connections and different dependencies between risk variables within the delivery process. The risk variables shown in FIG. 2 have not been categorized by an expert; therefore the relationships between the different risk variables are highly chaotic. FIG. 3 depicts a Bayesian risk model 300 that benefits from the application of the present invention, i.e., the relationships between the risk variables are highly organized.

FIG. 3 is an example of a Bayesian risk model 300 that may be obtained after the learning method is applied to the risk matrix 100. The same risk variables present in FIG. 2 are also shown in FIG. 3. However, in FIG. 3, the risk variables were previously categorized by an expert into a risk matrix 100, as shown in FIG. 1, and a learning method, such as a Bayesian learning method, was applied to the risk matrix 100. Thus, a more orderly risk model 300 is obtained through the use of the learning method.

Once the learning method is applied to the risk matrix 100 and a risk model 300 is composed, the risk model 300 may be used to perform various risk analysis tasks such as risk diagnosis, risk impact analysis, risk prioritization, and risk mitigation strategy evaluation. In one embodiment, these risk analysis tasks are developed on principled approaches for Bayesian inferences in Bayesian networks.

Bayesian inference techniques can be used to analyze risk mitigation strategies and also to calculate risk impact. Bayesian inferences calculate the posterior probabilities of certain variables given observations on other variables. These inference techniques allow for an estimate of the likelihood of risk given new observations. Let e be the observed states of a set of variables E, and X be the target variable, and Y be all the other variables. The posterior probability of X given that we observe e can be calculated according to Equation 1 as follows:

$$P ( X \vert E = e ) = {\sum }_{Y} P ( X , Y \vert E = e ) \qquad ( 1 )$$

The jointree algorithm, as disclosed by Lauritzen's “Local computations with probabilities on graphical structures and their application to expert systems” Journal of the Royal Statistical Society, Series B (Methodological) 50(2):157-224, 1998, (Equation 1) allows the posterior probabilities for all the unobserved variables to be computed at once. Thus, a user can set a risk variable 120 to an observed state e and calculate the probability of the influence of the observed state e on the target variable X.

Once the risk mitigation strategies and performance measures are defined, a user can also analyze the sensitivity of different risk mitigation strategies on performance measures. For example, a user may want to test the sensitivity of performance measure M against risk mitigation strategy D given state observations e. The user excludes all the other risk mitigation strategies to isolate D. Then, risk mitigation strategy is set systematically to its different states, which results in different joint probability distributions over the unobserved variables X. For each state, the average expected utility value is computed as according to Equation 2 as follows:

$$EU ( D = d ) = {\sum }_{X} P ( X \vert E = e , D = d ) U ( x ) \qquad ( 2 )$$

Then, the difference between the minimum and the maximum of the expected utility values can be used to calculate the impact or sensitivity of the performance measure to the risk mitigation strategy given certain observations.

Monte Carlo simulation methods can be used to estimate the utility distribution for any selected action of a mitigation strategy EU_{M}−(D−d|E=e). These methods are useful when the risk model is intractable for exact methods, or if the calculation requires a probabilistic distribution rather than a single expected value. In one embodiment, for a particular state d of D and evidence e, an algorithm known as likelihood weighting is used to evaluate the Bayesian risk model.

Forward sampling is used for the simulation. Each unobserved variable X is sampled a state according to its conditional probability distribution given its predecessor variables. Whenever an observed variable is encountered, its observed state is used as part of the sample state. However, this forward sampling process produces biased samples because it is not sampling from the correct posterior probability distribution of the unobserved variables given the observed evidence. The bias should be corrected with weights assigned to the samples. The formula for computing the weights is given as follows:

$$\begin{matrix}{EU}_{M} ( D = d \vert E = e ) = {\sum }_{X} P ( X \vert E = e , D = d ) {U}_{M} ( X = x ) \\ = \frac{{\sum }_{X} P ( X , E = e \vert D = d ) {U}_{M} ( X = x )}{P ( E = e \vert D = d )} \\ = {\sum }_{x} \frac{P ( E = e \vert X = x , D = d )}{P ( E = e \vert D = d )} \\ P ( X = x \vert D = d ) {U}_{M} ( X = x )\end{matrix} \qquad ( 3 )$$

Therefore, P(X|D=d) can be used as the sampling distribution to do forward sampling. The bias of each sample xᵢ is corrected by assigning its utility value U_{M}(xᵢ) with weight P(E−e|X=xᵢ, D=d)|P(E=e|D=d).

The process can be repeated to produce a set of N weighted samples and the samples can be used to estimate the expected utility value EU_{M} according to Equation 4:

$${EU}_{M} ( D = d \vert E = e ) \approx \frac{1}{N} {\sum }_{{x}_{i}} \frac{P ( E = e \vert {x}_{i} , D = d )}{P ( E = e \vert D = d )} {U}_{M} ( {x}_{i} ) , \qquad ( 4 )$$

where P (E=e|D=d) can be estimated according to Equation 5:

$$P ( E = e \vert D = d ) = {\sum }_{x} P ( E = e \vert X = x , D = d ) P ( X = x , D = d ) \approx \frac{1}{N} {\sum }_{{x}_{i}} P ( E = e \vert {x}_{i} , D = d ) \qquad ( 5 )$$

The sample weights can also be normalized to estimate a distribution over the different utility values instead of a single expected value.

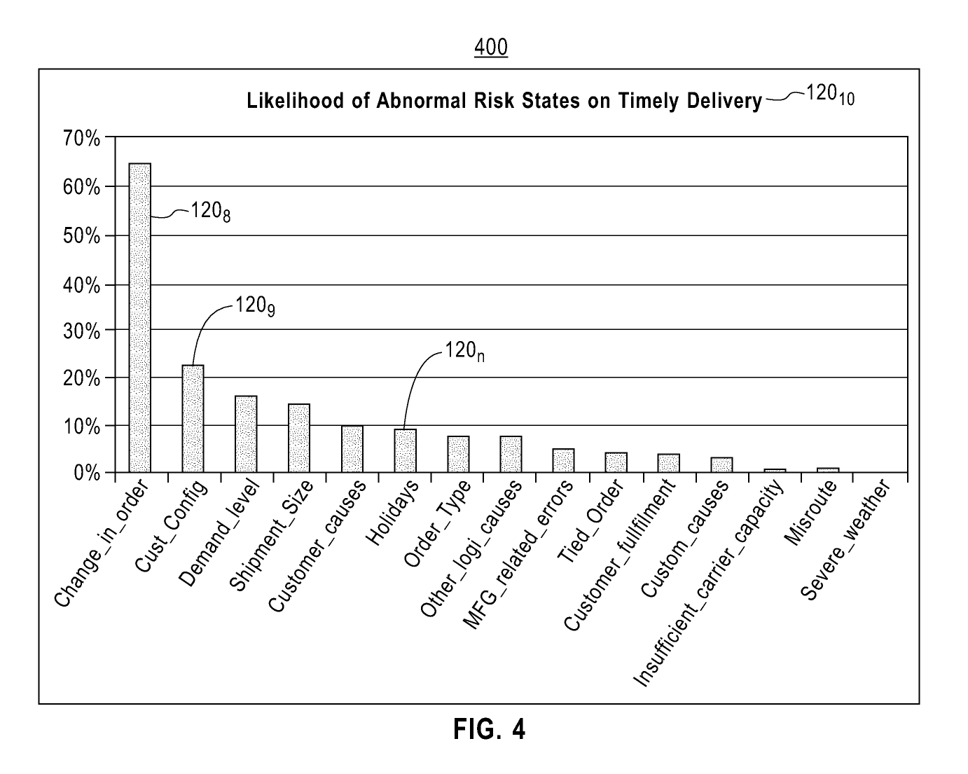

FIG. 4 is an example of a risk diagnosis bar chart 400 that illustrates the likelihood of different risk variables 120 having an effect on timely delivery of a custom computer system. The risk variable “customer changes order” 120₈ is the most likely risk variable affecting “timely delivery” 120₁₀ of a custom computer system to a customer.

Risk diagnosis, i.e., the likelihood of a risk event occurring given a certain evidence, can be computed based on the posterior probability distributions of the variables. In one embodiment of the invention, risk diagnosis is calculated according to Equation 1 as provided above. Returning to FIG. 1, as an example, assume the risk variable “fuel price” 120₂ is the target variable of interest for the purpose of risk diagnosis. Risk variable “fuel price” 120₂ is directly influenced by the risk variable “regulation” 120₃. Further assume that if regulation increases, the price of fuel will also increase. Therefore, if the probability that regulation will increase is high, then the probability that fuel price will increase is also high. Knowing the probability distribution of an increase in regulation, i.e., the evidence, allows for risk diagnosis of the target risk variable “fuel price” 120₂.

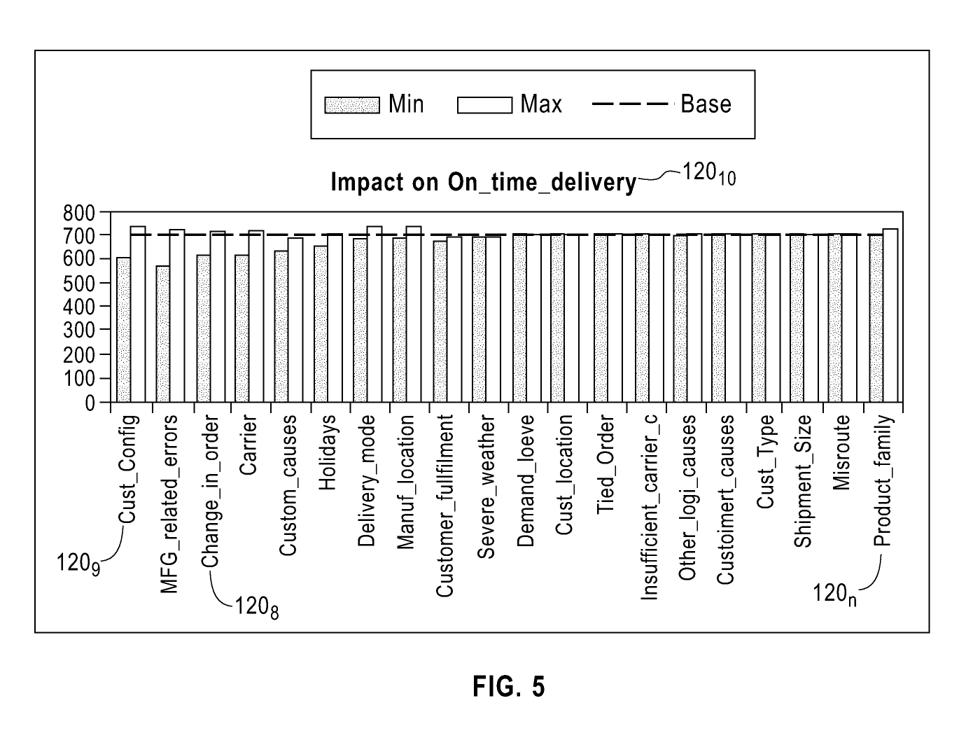

FIG. 5. is an example of a risk impact bar chart 500 that illustrates the impact of risk variables 120 on a performance measure. In one embodiment of the invention, risk impact is calculated from the expected utility values of Equation 2 as provided above. As related to the present example, the risk variable custom configuration 120₉ has the greatest impact on timely delivery of a custom computer system to a customer.

For example, the risk variable “custom configuration” 120₉ is set to various states and the expected value of the given performance measure (“timely delivery” 120₁₀) is calculated. Maximum and minimum values for the performance measure are calculated from these different states. The difference between the maximum and the minimum performance measure values is the impact of the risk variable on the performance measure. As shown in FIG. 5, setting the risk variable “custom configuration” 120₉ to various states results in the performance measure “timely delivery” 120₁₀ having a minimum value of approximately 600 and a maximum value of approximately 750. The difference between these maximum and minimum values is greater than any of the other differences indicated by the risk impact bar chart 500. Therefore, the risk variable “custom configuration” 120₉ has the greatest impact on the performance measure “timely delivery” 120₁₀.

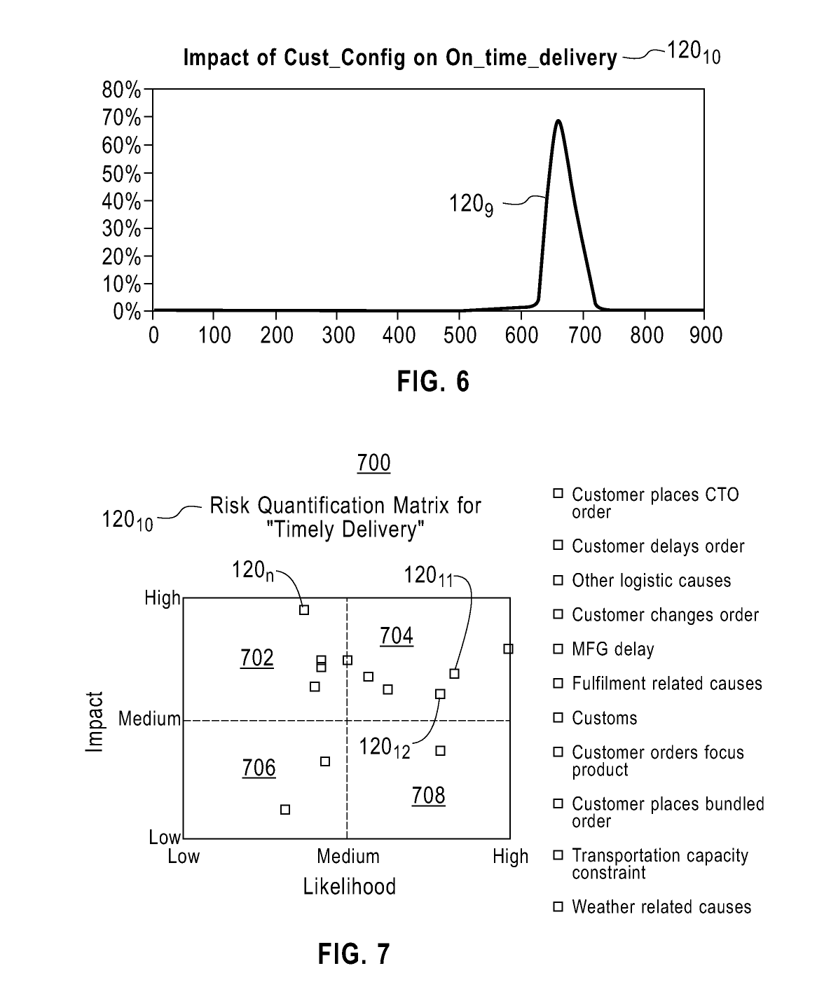

FIG. 6 is an example of a Monte Carlo analysis 600 (based on Equation 3) depicting the probabilistic distribution the risk variable “custom configuration” 120₉ will have an effect on the performance measure “timely delivery” 120₁₀. The probabilistic distribution is calculated by setting the risk variable “custom configuration” 120₉ to different states based upon historical data. The Monte Carlo analysis provides a probabilistic distribution of a risk variable 120 having an effect on a performance measure. For example, risk “variable custom configuration” 120₉ has a probabilistic mode of approximately 70%, i.e., “custom configuration” 120₉ will affect the performance measure “timely delivery” 120₁₀ 70% of the time.

Risk mitigation strategy evaluation is quantified by adding a new risk variable to the risk model. Performance measures are calculated with the new risk variable turned off and calculated again with the new risk variable turned on in the risk model. An increase or a decrease in the performance measure indicates the effectiveness of the new risk variable on the risk model.

The above methodology may also be used to rank different risk diagnoses and risk mitigation strategies. A scenario may be evaluated by setting an individual risk variable 120 to its different possible states, while all of the other risk variables in the risk model 300 remain unobserved. By changing the state of only one risk variable 120 in the risk model 300, different outcomes due to the changed risk variable 120 on the performance measure can be calculated. The different risk diagnoses and risk mitigation strategies can then be ranked or ordered based upon their effect on the targeted performance measure. A report of the rankings, i.e., the effectiveness of a mitigation strategy or risk diagnosis, is then provided to the user. In one embodiment, the report is a table such as a list of impact values, see FIG. 5.

FIG. 7 is an example of a risk quantification matrix 700 that is provided as an output to a user requesting risk quantification. The risk quantification matrix 700 is divided into four sectors, high impact-low likelihood 702, high impact-high likelihood 704, low impact-low likelihood 706, and low impact-high likelihood 708. The risk quantification matrix 700 may be constructed from the risk impact bar chart 500 and the Monte Carlo analysis 600 performed for each risk variable 120. In one embodiment, the risk likelihood derived from the Monte Carlo analysis is plotted along the X-axis and the risk impact is plotted along the Y-axis of the matrix 700. The risk variables 120 most likely to have an effect on a performance measure such as “timely delivery” 120₁₀ are located in the upper left-hand corner of the risk quantification matrix 700. These risk variables 120, such as “customer changes order” 120₁₁ and “customer orders focus product” 120₁₂ have the highest likelihood of occurrence and also the highest impact on the performance measure “timely delivery” 120₁₀. Therefore, the user requesting the risk quantification analysis will know to provide greater attention to these two particular risk variables 120₁₁ and 120₁₂. The user can then decide to apply different risk mitigation strategies that reduce the likelihood of a risk occurrence, or reduce the impact associated with risk variables 120₁₁ and 120₁₂.

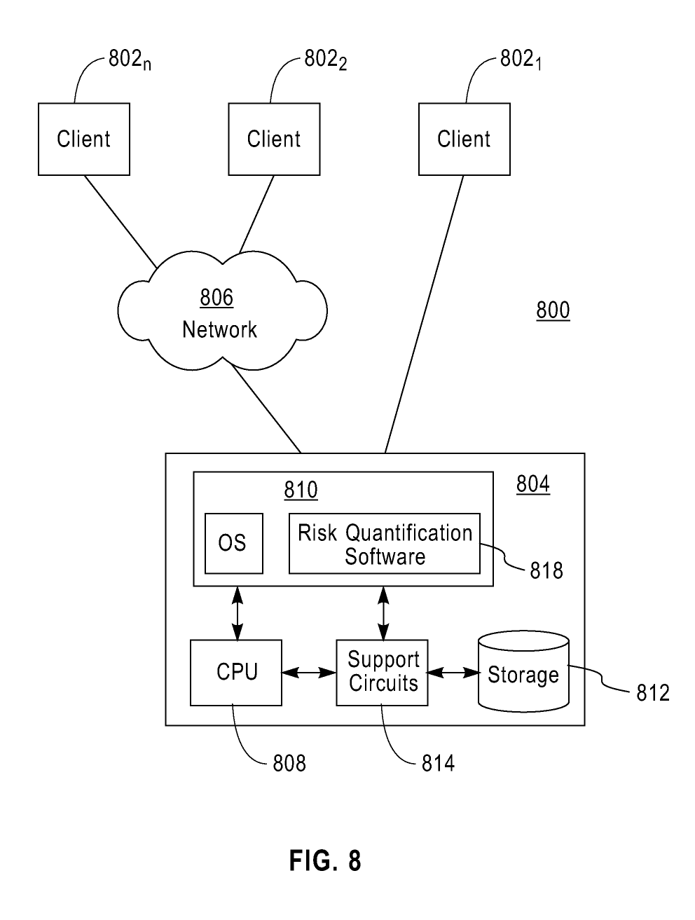

FIG. 8 is an example of a system architecture 800 that can benefit from the present invention. The architecture 800 comprises one or more client computers 802 connected to a server 804. The client computers 802 may be directly connected to the server 804, or indirectly connected to the server 804 via a network 806 such as the Internet or Ethernet. The client computers 802 may include desktop computers, laptop computers, personal digital assistants, or any device that can benefit from a connection to the server 804.

The server 804 comprises a processor (CPU) 808, a memory 810, mass storage 812, and support circuitry 814. The processor 808 is coupled to the memory 810 and the mass storage 812 via the support circuitry 814. The mass storage 812 may be physically present within the server 804 as shown, or operably coupled to the server 804 as part of a common mass storage system (not shown) that is shared by a plurality of servers. The support circuitry 812 supports the operation of the processor 808, and may include cache, power supply circuitry, input/output (I/O) circuitry, clocks, buses, and the like.

The memory 810 may include random access memory, read only memory, removable disk memory, flash memory, and various combinations of these types of memory. The memory 810 is sometimes referred to as a main memory and may in part be used as cache memory. The memory 810 stores an operating system (OS) 816 and risk quantification software 818. The server 804 is a general purpose computer system that becomes a specific purpose computer system when the CPU 808 runs the risk quantification software 818.

The risk quantification software 818 utilizes the learning method to compose a risk model 300 from the risk matrix 100. The architecture 800 allows a user to request a risk quantification from the server 804. The server 804 runs the risk quantification software 818 and returns an output to the user. In one embodiment of the invention, the server 804 returns a risk quantification matrix, as shown in FIG. 7, to the user. The risk quantification software 818 allows the user to analyze and diagnosis different risk variables and risk mitigation strategies. Thus, the method, system, and software identifies and quantifies business risks and their effect on the performance of a business process.

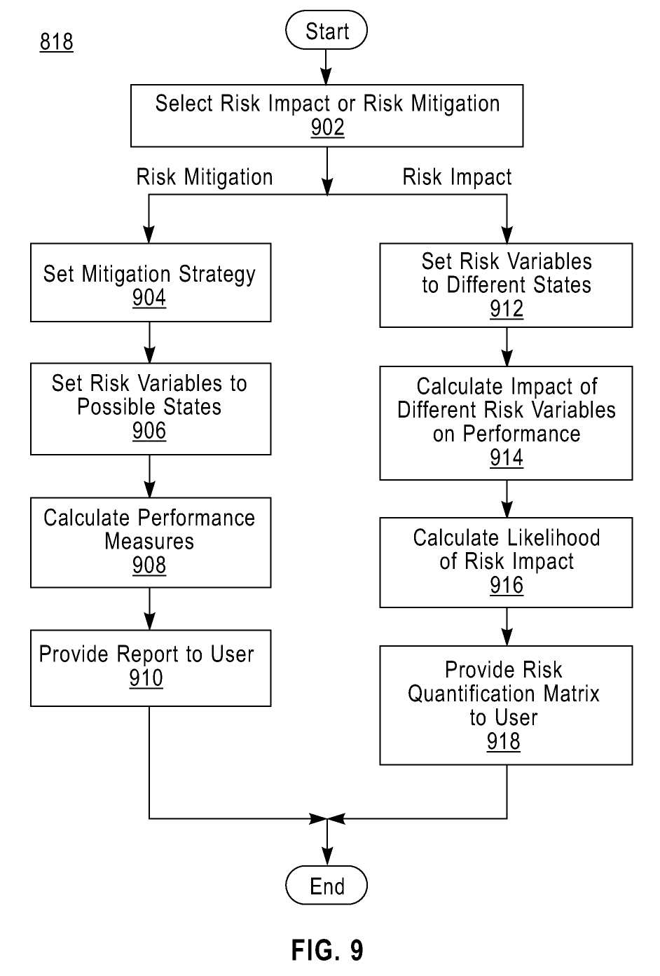

FIG. 9 is a flowchart illustrating one example of risk quantification software 818 that can benefit from the present invention. The risk quantification software 818 can analyze a risk mitigation strategy and perform a risk impact analysis using the methods and equations described above. Beginning at block 902, a user selects between a “risk mitigation” analysis and a “risk impact” analysis. If the user selects “risk mitigation” analysis then the software 818 branches off to block 904. If the user selects “risk impact” analysis then the software 818 branches off to block 912.

At block 904, the user selects a risk mitigation strategy. In one embodiment, the mitigation strategy introduces a new risk variable 120 into the risk matrix 100. In another embodiment, the user sets an existing risk variable 120 to a given state based upon the mitigation strategy. At block 906, the remaining risk variables 120 are set to their different possible states. The state of the mitigation strategy always remains constant during the analysis, but the state of the remaining risk variables 120 may change. At block 908, the software 818 calculates a performance measure from the risk variables 120. In one embodiment, the software calculates the performance measure according to Equation 3. The performance measure is directly influenced by the risk mitigation strategy and the changing states of the risk variables. A report similar to FIG. 5, indicating the effect of the risk mitigation strategy on the performance measure and the risk variables 120 is provided to the user at block 910. The user may re-run the risk mitigation strategy by changing the risk mitigation strategy selected at block 904. This allows the user to compare different risk mitigation strategies and their effect on performance measures.

At block 912, the user sets a risk variable 120 to its different possible states and the software 818 calculates the effect of these different states on a performance measure. In one embodiment, the software calculates the performance measure according to Equation 1. At block 914 the impact of a risk variable 120 is calculated by taking the difference between the minimum and the maximum value of the performance measure under evaluation. As the state of the risk variable changes 120, the calculated value of the performance measure also changes. Thus, the impact of different risk variables 120 on a performance measure can be calculated by systematically varying the states of an individual risk variable 120 while holding the remaining risk variables 120 in a constant state.

At block 916, the likelihood of a risk impact is calculated. In one embodiment, the software 818 calculates the likelihood of a risk impact by use of a Monte Carlo analysis according to Equation 3. In another embodiment, an expert may input the likelihood of a risk impact into the software 818. As shown in FIG. 7, the risk impact and the likelihood of the risk impact can be used to generate a risk quantification matrix 700. The risk quantification matrix 700 is provided to the user at block 918.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performing system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction performing system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which operate via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

Referring now to FIGS. 1 through 9. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

1. A computer implemented method for quantifying risk, the method comprising:
forming a two-dimensional risk matrix, wherein a first dimension comprises risk variable categories and a second dimension comprises one or more business processes;
including a risk variable in the two-dimensional risk matrix, wherein the risk variable is categorized by one of the risk variable categories and one of the business processes;
associating the risk variable with a target risk variable in the two-dimensional risk matrix, wherein the risk variable provides an input to the target risk variable; and
applying a learning method to the two-dimensional risk matrix to compose a risk model to use for quantifying the risk, wherein a program using a processor unit runs one or more of said forming, including, associating, and applying steps.

2. The method of claim 1, wherein the learning method comprises a Bayesian learning method.

3. The method of claim 2, further comprising:
calculating a probability distribution of the target variable based upon an observed state of the risk variable.

4. The method of claim 2, further comprising:
setting the risk variable to a first state;
setting the target risk variable to a second state; and
calculating a value of the target variable based upon the second state given the first state.

5. The method of claim 3, further comprising analyzing a plurality of scenarios by:
setting the observed state to a first value;
calculating the probability distribution of the target variable based upon the first value;
setting the observed state to a second value;
calculating the probability distribution of the target variable based upon the second value;
ranking each scenario based upon the calculated probability distributions; and
producing a report that provides rankings of each scenario.

6. The method of claim 1, further comprising analyzing an impact of a risk variable on a performance measure by:
setting the risk variable to a first state;
calculating a first performance measure given the risk variable in the first state;
setting the risk variable to a second state;
calculating a second performance measure given the risk variable in the second state; and
measuring the impact on the performance measure by calculating a difference between the first performance measure and the second performance measure.

7. The method of claim 6, further comprising measure a likelihood of a risk by:
setting the risk variable to a first state;
calculating a probability distribution of a target node in a second state given the risk variable in the first state; and
producing a risk quantification matrix that provides the impact of the risk variable and the likelihood of the risk for the risk variable.

8. A computer program product for quantifying risk, comprising:
a storage medium readable by a processor and storing instructions for operation by the processor for performing a method comprising:
forming a two-dimensional risk matrix, wherein a first dimension comprises risk variable categories and a second dimension comprises business processes;
including a risk variable in the two-dimensional risk matrix, wherein the risk variable is categorized by one of the risk variable categories and one of the business processes;
associating the risk variable with a target risk variable in the two-dimensional risk matrix, wherein the risk variable provides an input to the target risk variable; and
applying a learning method to the two-dimensional risk matrix to compose a risk model to use for quantifying the risk.

9. The computer program product for quantifying risk of claim 8, wherein the learning method applied is a Bayesian learning method.

10. The computer program product for quantifying risk of claim 8, the computer program product further comprising:
calculating a probability distribution of the target variable based upon an observed state of the risk variable.

11. The computer program product for quantifying risk of claim 8, the computer program product further comprising:
setting the risk variable to a first state;
setting the target risk variable to a second state; and
calculating a value of the target variable based upon the second state given the first state.

12. The computer program product for quantifying risk of claim 10, the computer program product further comprising:
setting the observed state to a first value;
calculating the probability distribution of the target variable based upon the first value;
setting the observed state to a second value;
calculating the probability distribution of the target variable based upon the second value;
ranking each business scenario based upon the calculated probability distributions; and
producing a report that provides rankings of each scenario.

13. The computer program product for quantifying risk of claim 8, the computer program product further operable to analyze an impact of a risk variable on a performance measure by:
setting the risk variable to a first state;
calculating a first performance measure given the risk variable in the first state;
setting the risk variable to a second state;
calculating a second performance measure given the risk variable in the second state; and
measuring the impact on the performance measure by calculating a difference between the first performance measure and the second performance measure.

14. The computer program product for quantifying risk of claim 13, the computer program product further operable to measure a likelihood of a risk by:
setting the risk variable to a first state;
calculating a probability distribution of a target node in a second state given the risk variable in the first state; and
producing a risk quantification matrix that provides the impact of the risk variable and the likelihood of the risk for the risk variable.

15. A system for quantify risk, the system comprising:
a memory and a processor coupled to said memory operable to form a two-dimensional risk matrix, wherein a first dimension comprises risk variable categories and a second dimension comprises business processes, place a risk variable onto the two-dimensional risk matrix, wherein the risk variable is categorized by one of the risk variable categories and one of the business processes, associate the risk variable with a target risk variable in the two-dimensional risk matrix, wherein the risk variable provides an input to the target risk variable, and apply a learning method to the two-dimensional risk matrix to compose a risk model to use for quantifying the risk.

16. The system for quantifying risk of claim 15, wherein the processor is further operable to calculate a probability distribution of the target variable based upon an observed state of the risk variable.

17. The system for quantifying risk of claim 15, wherein the processor is further operable to set the risk variable to a first state, set the target risk variable to a second state, and calculate a value of the target variable based upon the second state given the first state.

18. The system for quantifying risk of claim 16, wherein the processor is further operable to set the observed state to a first value, calculate the probability distribution of the target variable based upon the first value, set the observed state to a second value, calculate the probability distribution of the target variable based upon the second value, rank each business scenario based upon the calculated probability distributions, and produce a report that provides rankings of each scenario.

19. The system for quantifying risk of claim 15, wherein the processor is further operable to set the risk variable to a first state, calculate a first performance measure given the risk variable in the first state, set the risk variable to a second state, calculate a second performance measure given the risk variable in the second state, and measure the impact on the performance measure by calculating a difference between the first performance measure and the second performance measure.

20. The system for quantifying risk of claim 19, wherein the processor is further operable to set the risk variable to a first state, calculate a probability distribution of a target node in a second state given the risk variable in the first state, and produce a risk quantification matrix that provides the impact of the risk variable and the likelihood of the risk for the risk variable.
